(19) United States
(12) Patent Application Publication
(10) Pub. No.: US 2021/0133674 A1
(43) Pub. Date: May 6, 2021

(54) PICKING WORK ASSISTANCE DEVICE AND COMPUTER-READABLE RECORDING MEDIUM HAVING STORED THEREON PICKING WORK ASSISTANCE PROGRAM

(71) Applicant: SHARP KABUSHIKI KAISHA, Sakai City (JP)

(72) Inventors: AMI HADA, Sakai City (JP); NAOKI TANI, Sakai City (JP); HIROSHI MURAOKA, Sakai City (JP); SHIGERU AOYAMA, Sakai City (JP); KAZUSHI KUWAHATA, Sakai City (JP); HIROSHI YAMAUCHI, Sakai City (JP)

(21) Appl. No.: 17/083,872

(22) Filed: Oct. 29, 2020

(30) Foreign Application Priority Data
Oct. 30, 2019 (JP) 2019-196948

(51) Int. Cl. G06Q 10/08; G06Q 10/06; G06Q 10/04; B62B 5/00; B62B 3/10; B60K 35/00; G05D 1/02; G01C 21/20

(52) U.S. Cl. CPC G06Q 10/0875; G06Q 10/06315; G06Q 10/047; G06Q 10/06316; B62B 5/0096; G06K 7/10861; B60K 35/00; G05D 1/0212; G01C 21/206; G06Q 10/063114; B62B 3/10

(57) ABSTRACT

According to an embodiment, a tablet terminal, which functions as a guide image display portion, sequentially displays GUI images (guide images) that assist picking work inside a warehouse. The tablet terminal displays a guide image indicating a route to a shelf that stores the aimed commodity when an AGV starts to travel; displays a guide image indicating the shelf number and a tier level when the AGV is near the shelf that stores the aimed commodity; displays a guide image indicating a photograph of the commodity and a position of a bar code to be read by a bar code reader when the AGV is in front of the shelf that stores the aimed commodity; displays a guide image indicating a container in which the commodity should be put when the commodity is picked correctly; and displays the number of commodities for a final check.

### BACKGROUND OF THE INVENTION

### Field of the Invention

The present invention relates to a picking work assistance device and a computer-readable recording medium having stored thereon a picking work assistance program, and more particularly, to a picking assistance device and a computer-readable recording medium having stored thereon a picking assistance program for displaying, for example, an image of a commodity to be picked.

### Description of the Background Art

Japanese Unexamined Patent Application Publication No. 2006-306505 discloses a picking assistance system which displays an image of a commodity to be picked in accordance with the unit of picking.

Japanese Unexamined Patent Application Publication No. 2001-130721 discloses a picking system which displays a style of packing of commodities to be shipped, which are stacked on a pallet.

The background art described above, i.e., the technology of both Japanese Unexamined Patent Application Publication No. 2006-306505 and Japanese Unexamined Patent Application Publication No. 2001-130721, merely displays a commodity or the style of packing. Thus, the above technology is not sufficient to prevent incorrect picking by a worker in multi-picking (i.e., the work to collect commodities for multiple delivery destinations at one time by using multiple containers), in particular.

Therefore, a main object of the present invention is to provide a new picking work assistance device and a computer-readable recording medium having stored thereon a picking work assistance program.

Another object of the present invention is to provide a picking work assistance device and a computer-readable recording medium having stored thereon a picking work assistance program capable of preventing incorrect picking by a worker as much as possible, particularly in multi-picking.

### SUMMARY OF THE INVENTION

A first invention pertains to a picking work assistance device which assists multi-picking work of sequentially picking commodities that are each stored in a storage area, using a carrier vehicle on which a plurality of containers corresponding individually to a plurality of customers, respectively, are placed, in which the picking work assistance device includes a picking work target registrator that registers a commodity, which is a picking work target, and a container indicator that indicates which of the plurality containers the picked commodity is to be put in.

In the first invention, by having the plurality of containers corresponding to the customers individually placed on one carrier vehicle, multi-picking, which is to collect commodities ordered by multiple customers in a single picking work operation, is performed. In doing so, a picking worker picks the commodity registered by the picking work target registrator, and puts the commodity in one of the plurality of containers indicated by the container indicator.

According to the first invention, the container indicator, which indicates which of the plurality containers the picked commodity is to be put in, is provided, and therefore, in the multi-picking, it is possible to prevent the picked commodity from being put in an incorrect container, for example, as much as possible.

A second invention depends on the first invention, and pertains to a picking work assistance device in which the carrier vehicle includes a guide image display portion, which is removably provided on the carrier vehicle, and guides the picking work, and the container indicator displays, by the guide image display portion, a container guide image as a guide to the container in which the commodity should be put from among the plurality of containers.

According to the second invention, by displaying the container in which the commodity should be put by means of the container guide image, it is possible to more effectively prevent a commodity loading error to be made by the picking worker.

A third invention depends on the second invention, and pertains to a picking work assistance device in which the guide image display portion displays, when the carrier vehicle arrives at the storage area of the commodity registered by the picking work target registrator, a commodity guide image showing information on the commodity to be picked.

According to the third invention, since the picking worker picks the commodity in accordance with the commodity guide image, it is possible to prevent an incorrect commodity from being picked, for example, in the multi-picking as much as possible.

A fourth invention depends on the second or third invention, and pertains to a picking work assistance device in which the guide image display portion displays, when the carrier vehicle is close to the storage area of the commodity, a storage area guide image showing information on that storage area.

According to the fourth invention, since the picking worker can confirm the storage area when the carrier vehicle has come close to the storage area of the commodity to be picked, a picking error can be further prevented.

A fifth invention depends on any one of the first to fourth inventions, and pertains to a picking work assistance device in which the picking work assistance device further includes a route information generator which generates information on a traveling route for the carrier vehicle to perform the picking work of the commodity registered by the picking work target registrator, on the basis of map data and the information on the storage area of the registered commodity.

According to the fifth invention, since the traveling route for the carrier vehicle is displayed as a guide image as needed, it is possible to guide the picking worker effectively in a case where the carrier vehicle is not an AGV that can autonomously travel.

A sixth invention depends on the fifth invention, in which the route information generator generates route information on the basis of information on a plurality of storage areas corresponding to commodities, which are the picking work targets, of a plurality of customers for whom the multi-picking is intended.

According to the sixth invention, since the route information is generated on the basis of the information on the plurality of storage areas, it is possible to generate an efficient traveling route in the multi-picking.

A seventh invention depends on the sixth invention, and pertains to a picking work assistance device in which the route information generator sorts the commodities, which are the picking work targets, of the plurality of customers by the storage areas, and generates the route information such that the commodities, which are the picking work targets, sorted by the storage areas are sequentially picked.

According to the seventh invention, since the route information is generated on the basis of a result of sorting of the plurality of storage areas, it is possible to generate an even more efficient traveling route in the multi-picking.

An eighth invention depends on any one of the first to seventh inventions, and pertains to a picking work assistance device in which the carrier vehicle includes, at places corresponding to positions where the plurality of containers are placed, an informing portion that informs which of the plurality of containers the commodity is to be put in, and the container indicator indicates, by means of the informing portion, the container in which the commodity should be put from among the plurality of containers.

According to the eighth invention, the container indicator can use the informing portion to indicate the container in which the commodity should be put.

A ninth invention pertains to a non-transitory computer-readable recording medium having stored thereon a picking work assistance program which is executed by a computer of a picking work assistance device, which assists multi-picking work of sequentially picking commodities that are each stored in a storage area, using a carrier vehicle on which a plurality of containers corresponding individually to a plurality of customers, respectively, are placed, in which the picking work assistance program causes the computer to function as a picking work target registrator that registers a commodity, which is a picking work target, and a container indicator that indicates which of the plurality containers the picked commodity is to be put in.

According to the ninth invention, the same advantage as that of the first invention can be expected.

### BRIEF DESCRIPTION OF THE DRAWINGS

FIG. 1 is a block diagram showing a picking work assistance device according to an embodiment of the present invention;

FIG. 2 is an illustration showing a part of a warehouse in which commodities are collected by using the picking work assistance device of the embodiment of FIG. 1;

FIG. 3 is an illustration showing a part of the order details received by an order reception computer of the embodiment of FIG. 1;

FIG. 4 is an illustration showing an example of a delivery request label (a sticker) to be printed by a sticker printer of the embodiment of FIG. 1;

FIG. 5 is an illustration showing an example of an AGV of the embodiment of FIG. 1;

FIG. 6 is an illustration showing an example of the arrangement on a bottom surface of the AGV of the embodiment of FIG. 5;

FIG. 7 is a block diagram showing an example of an electrical configuration of the AGV of the embodiment of FIG. 5, together with a tablet terminal;

FIG. 8 is an illustration showing an example of a memory map of a memory of the tablet terminal shown in FIG. 7;

FIG. 9 is a flowchart showing an example of preprocessing of picking work to be conducted by the tablet terminal;

FIG. 10 is a flowchart showing an example of preprocessing of picking work to be conducted by a picking work management server;

FIG. 11 is a flowchart showing an example of picking work performed using the tablet terminal;

FIG. 12 is an illustration showing a first GUI image displayed on the tablet terminal in the picking work performed using the tablet terminal;

FIG. 13 is an illustration showing a second GUI image displayed on the tablet terminal in the picking work performed using the tablet terminal;

FIG. 14 is an illustration showing a third GUI image displayed on the tablet terminal in the picking work performed using the tablet terminal;

FIG. 15 is an illustration showing a fourth GUI image displayed on the tablet terminal in the picking work performed using the tablet terminal;

FIG. 16 is an illustration showing a fifth GUI image displayed on the tablet terminal in the picking work performed using the tablet terminal; and

FIG. 17 is an illustration showing a part of an AGV in another embodiment of the present invention.

### DESCRIPTION OF THE PREFERRED EMBODIMENTS

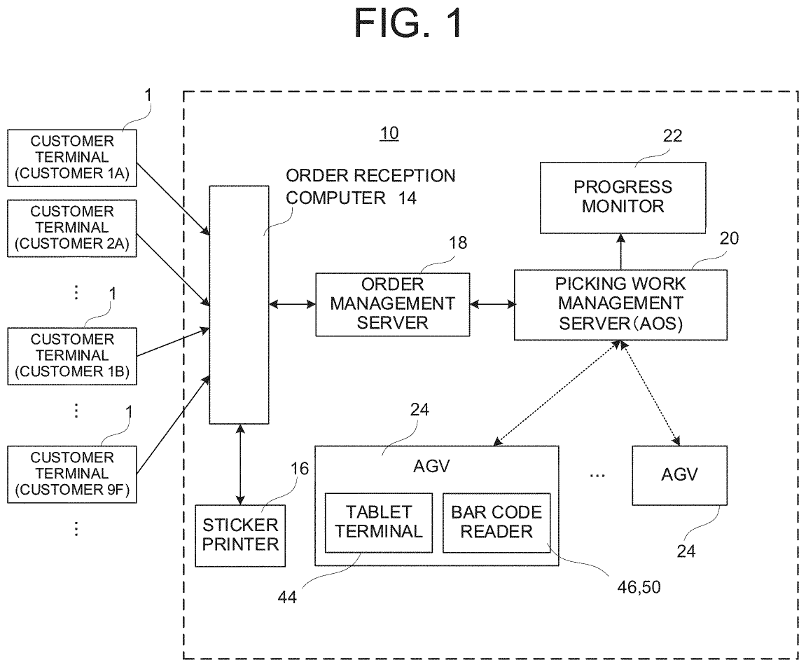

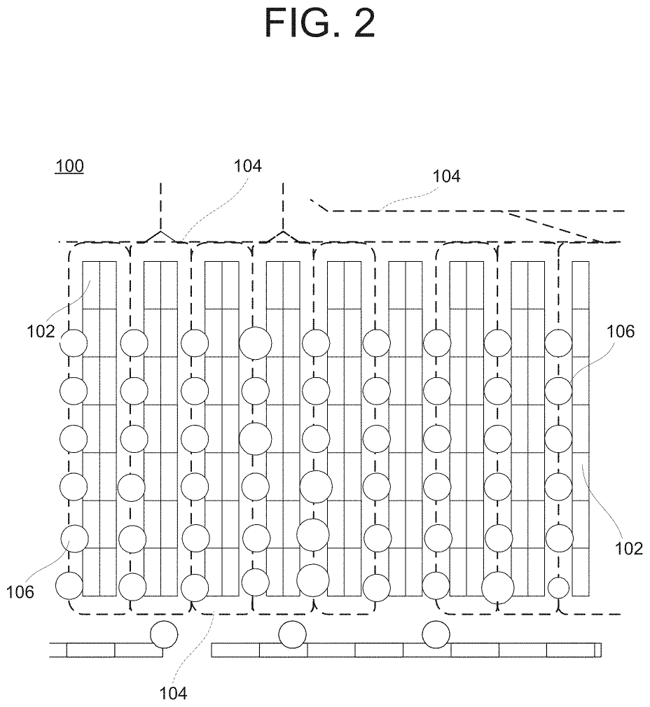

Referring to FIG. 1, a picking work assistance device 10 of the present embodiment will be described. The picking work assistance device 10 assists the picking work of collecting, in accordance with an order from each customer (delivery destination) 1A, 2A, . . . , 1B, . . . 9F, goods or commodities (hereinafter referred to as “commodities”) which the order information indicates in a warehouse 100 shown in FIG. 2, and delivering the commodities to the customer who ordered the commodities.

In the warehouse 100, shelves 102, as storage areas, on which each of the commodities (not shown) is placed and stored, are arranged. The shelves 102 are installed such that two rows of shelves form one set or block, and a magnetic tape 104, which indicates a route for an AGV 24 to be described later to autonomously travel, is laid between those blocks of shelves. However, other than between the blocks of shelves, the magnetic tape 104 is laid at a place where the AGV 24 needs to be guided. Note that a place indicated by a white circle 106 in FIG. 2 represents a position where the AGV 24 can stop or turn during pickup (picking) work.

Also, although not illustrated in FIG. 2, in the present embodiment, RF tags are laid on a floor on which the AGV 24 travels, i.e., a traveling route of the AGV 24, in the warehouse 100, in order to accurately ascertain the current position of the AGV 24. Further, although not illustrated, a plurality of access points are provided in the warehouse 100, and the AGV 24 and a tablet terminal 44 to be described later perform communication (data transmission/reception) with a picking work management server 20, etc., via a network including the above access points.

The order information is received from customer terminals 1, 1, . . . of the customers (delivery destinations) 1A, 2A, . . . , 1B, . . . 9F, via the Internet, for example, at the time determined for each customer (ticketing time: 4 to 5 times a day, for example). The order information is input to an order reception computer 14 included in the picking work assistance device 10. The order reception computer 14 is a general-purpose computer, and stores the received order details in a memory (not shown). The order details are updated every time the order information is input from the customer terminal 1. In other words, since the order reception computer 14 registers the commodity, which is a target of the picking work, the order reception computer 14 functions as a picking work target commodity registrator.

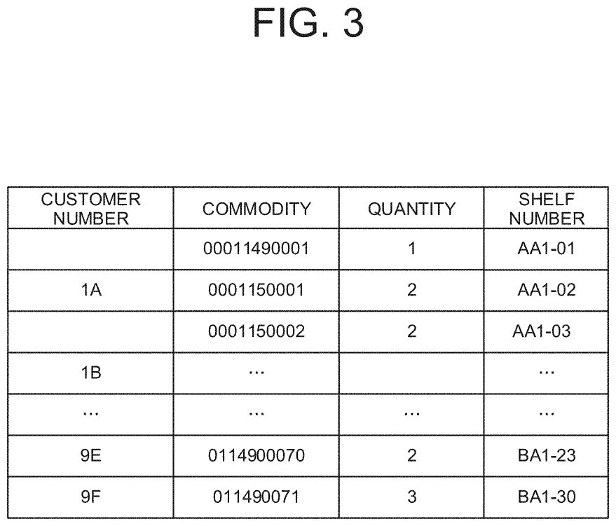

FIG. 3 shows an example of a part of the order details. In this example, the order details include a commodity number of the commodity which has been ordered, the number of commodities being requested, and the number of the shelf 102 in the warehouse 100 where the commodity is stocked, for each of the customers 1A, 1B, . . . , etc.

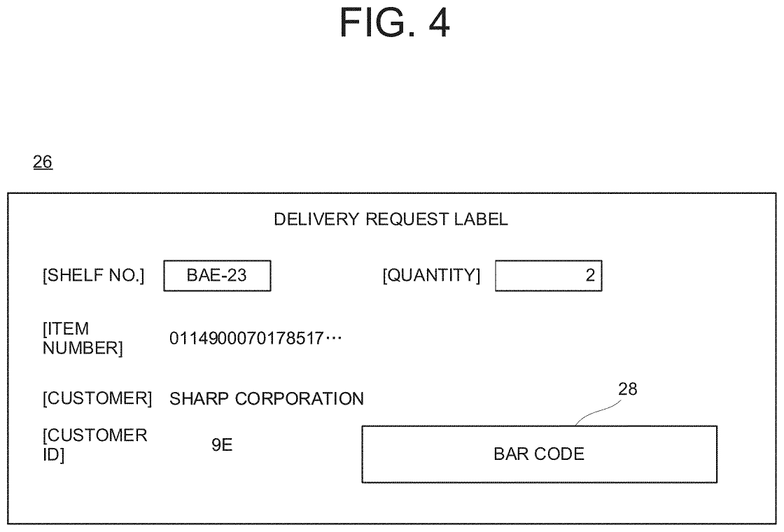

The order reception computer 14 causes an accompanying sticker printer 16 to print a sticker (delivery request label) 26 as shown in FIG. 4 according to the order information. Here, the sticker 26 is printed for each customer corresponding to the delivery destination, and for each type (item number) of the commodity. For example, in a case where customer 1A ordered only one type of commodity, one sticker is printed. When customer 1A ordered two types of commodities, a total of two stickers, i.e., a separate sticker for each one of the two types of commodities, are printed. If an order unit of one type of commodity is plural (i.e., in the case of a bulk purchase), a sticker is issued for each unit of the bulk purchase.

On the sticker 26, the item number of the commodity, quantity, shelf number, the name of the customer, and the customer ID are indicated, and a bar code 28 including all of the aforementioned items of information is printed. Note that the bar code 28 may be a one-dimensional bar code or a two-dimensional bar code. Here, the shelf number corresponds to detailed information about the storage area, and the item number of the commodity and the quantity correspond to detailed information about the commodity.

The order reception computer 14 causes the sticker printer 16 to print the sticker 26 in this way, and transmits print result information to an order management server 18.

The order management server 18 may be a general-purpose computer, and includes a central processing unit (CPU), a communication device connected to the CPU via an internal bus, and a memory, although none of the above elements is shown in the drawing. The order management server 18 can communicate with the order reception computer 14 and the picking work management server 20, etc., via the above-described communication device, and can exchange data with the element in communication. In addition, the memory includes a ROM and a RAM, and the print result information received from the order reception computer 14 is accumulated in the memory for each customer.

When the order management server 18 receives the print result information from the order reception computer 14, the order management server 18 updates the order data accumulated in the memory (not shown), and transmits the additional order data to the picking work management server (AOS: AGV Operation System) 20.

The picking work management server 20 includes a progress monitor 22, and displays the state of progress of the picking work as a whole in the form of, for example, squares corresponding to the orders individually. More specifically, the picking work management server 20 uses the square to display the state of progress of the picking work for the corresponding order by color, such as in blue (normal), orange (delay), or gray (complete).

The picking work management server 20 may be a general-purpose computer, and includes a CPU and a communication device, though not shown. The picking work management server 20 can communicate with the order management server 18, the AGV 24, and the like, via the communication device, and can exchange data with the element in communication. In addition, the picking work management server 20 includes a memory (not shown), and the memory stores programs (an OS, a picking work management program, etc.) that are necessary for the picking work management server 20.

As described above, the picking work management server 20 includes the progress monitor 22, and displays the state of progress of the picking work as a whole.

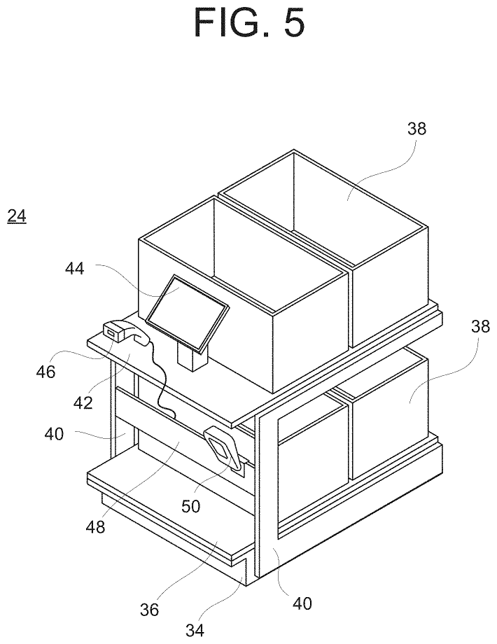

Referring to FIG. 5, the AGV 24 is described. The AGV 24 includes a platform truck 34, and the platform truck 34 is provided with a moving portion such as wheels (described later) on the lower surface thereof. The upper surface of the platform truck 34 is formed as a lower placement board 36 for placing a container 38 as a pickup container. Frames 40 are vertically attached to both side surfaces of the platform truck 34 along the both side surfaces.

At the upper ends of the frames 40, an upper placement board 42 for placing the container 38 is provided. The tablet terminal 44 is removably (detachably) installed near a front end of the upper surface of the upper placement board 42. The tablet terminal 44 is a computer including a CPU (a processor) and a memory as will be described later.

The tablet terminal 44 reads the bar code on all of the stickers, which are printed by the sticker printer 16, and which one picking worker should handle, to notify the picking work management server 20 of the read bar codes, and displays a guide image (GUI image) for the picking worker, which is one of the features of the present embodiment.

A handy-type bar code reader 46 for reading a bar code as a commodity ID assigned to the commodity is provided near the tablet terminal 44 of the upper placement board 42, and a fixed bar code reader 50 is provided on a mounting plate 48 connecting between the left and right frames 40 at a front end of the frames 40.

Note that, in the present embodiment, while four containers 38 can be placed on the AGV 24, the number of containers that can be placed may be arbitrary.

Further, the container 38 is basically a bottom-closed box with the top being open. The container 38 includes, for example, a weight sensor which is installed at the bottom, and detects the weight of the commodity that has been put in; a volume sensor which is provided at a side wall, and detects the volume (size) of the commodity that has been put in; and a photosensor which is provided at an opening edge, and detects the input of the commodity. However, since the above elements are not directly relevant to the embodiment, illustration and description thereof are omitted.

Also, in a case where the sticker 26 (FIG. 4) is not a bar code, but an IC tag, an IC tag reader (not shown) is used instead of the bar code readers 46 and 50.

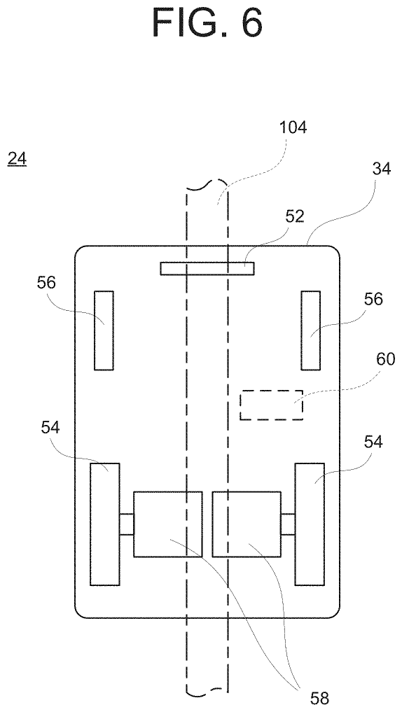

As shown in FIG. 6, a magnetic sensor 52 is provided on the lower surface of the platform truck 34 of the AGV 24. The magnetic sensor 52 detects the magnetic tape 104 laid in the warehouse 100, so that the AGV 24 autonomously travels.

Wheels 54 and 56 are provided on the lower surface of the platform truck 34 of the AGV 24. The wheels 54 are drive wheels, and the wheels 56 function as driven wheels. The drive wheels 54 are coupled to left and right motors 58 as a driving portion. In other words, as the drive wheels 54 are rotated by the motors 58, the AGV 24 travels. The AGV 24 is required to perform not only the normal forward traveling, but also the backward movement, turning, reversing, etc. For this reason, in the present embodiment, the drive wheels 54 are structured such that they can be independently driven by the left and right separate motors 58.

The AGV 24 is provided with a tag reader 60 for reading the RF tags (not shown) laid in the warehouse 100 (FIG. 2).

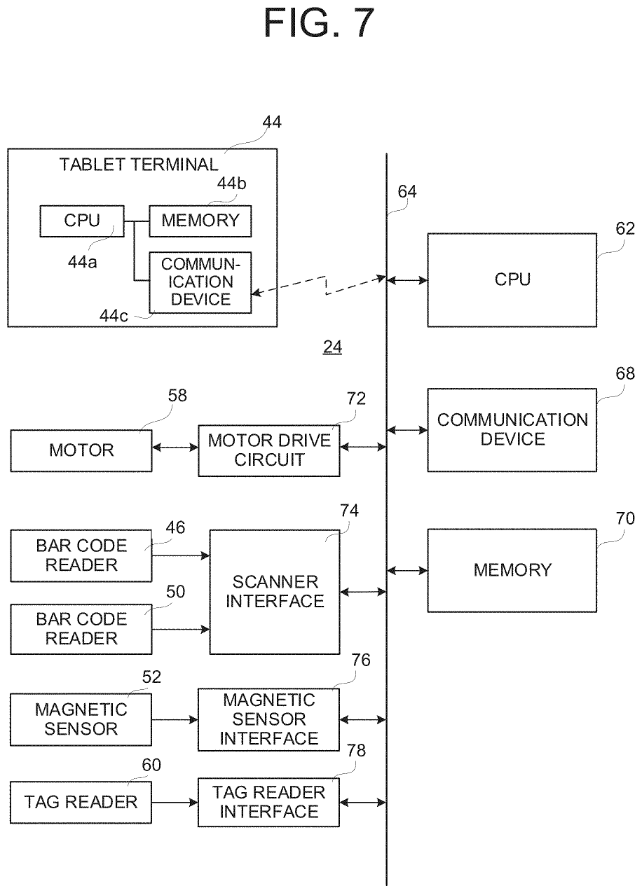

As described above, while the tablet terminal 44 is mounted on the AGV 24, the tablet terminal 44 may be provided for each picking worker or for each AGV 24. The tablet terminal 44 includes a touch display (a display with a touch screen), and also a CPU 44a, as shown in FIG. 7. A memory 44b and a communication device 44c are connected to the CPU 44a via an internal bus. The memory 44b includes a ROM and a RAM. In the memory 44b, a program for assisting the picking work is set, and data necessary for the picking work is stored therein, as will be described later. The communication device 44c is basically a wireless communication device, and mainly communicates with the picking work management server 20.

As shown in FIG. 7, the AGV 24 includes a CPU 62, and a communication device 68 is connected to the CPU 62 via an internal bus 64. The communication device 68 includes, for example, a network interface controller (NIC). The CPU 62 can communicate (wirelessly or by wire) with the picking work management server 20 and the tablet terminal 44 via the communication device 68, so that data can be exchanged with these elements in communication.

A memory 70 is further connected to the CPU 62 via the internal bus 64. The memory 70 includes a ROM and a RAM. Programs necessary for the AGV 24 (an OS, a traveling control program, etc.) are stored in the memory 70. The AGV 24 autonomously travels in accordance with map data that has been stored in the memory 70 in advance, and route data and the like sent from the picking work management server 20.

A motor drive circuit 72 including the motors 58 for driving the wheels 54 shown in FIG. 6 is connected to the CPU 62 through the internal bus 64, and drives the motors 58 (FIG. 6) in accordance with drive data from the CPU 62. In other words, the wheels 54 (56) of the AGV 24 are controlled by the CPU 62.

A scanner interface 74 receives a read signal from the bar code readers 46 and 50 shown in FIG. 5, and converts the read signal into bar code data. The bar code data is input to the CPU 62 through the internal bus 64, written in the memory 70 by the CPU 62, and transmitted to the tablet terminal 44.

A detection signal from the magnetic sensor 52 shown in FIG. 5 is input to a magnetic sensor interface 76. The detection signal is input to the CPU 62 by way of the magnetic sensor interface 76. Then, the CPU 62 controls the motor drive circuit 72 by the detection signal such that the AGV 24 travels along the route formed by the magnetic tape.

In the AGV 24, a read signal, which is obtained by the tag reader 60 for reading the above-mentioned RF tags, is further taken in from a tag reader interface 78 as positional data.

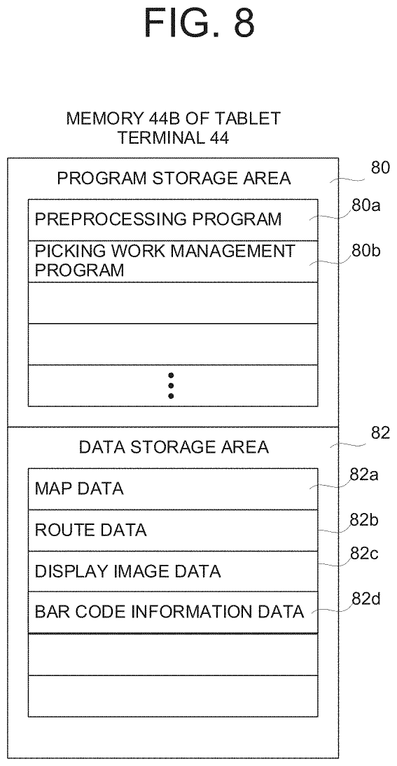

FIG. 8 shows an example of a memory map of the memory 44b of the tablet terminal 44, and the memory 44b includes a program storage area 80, and a data storage area 82.

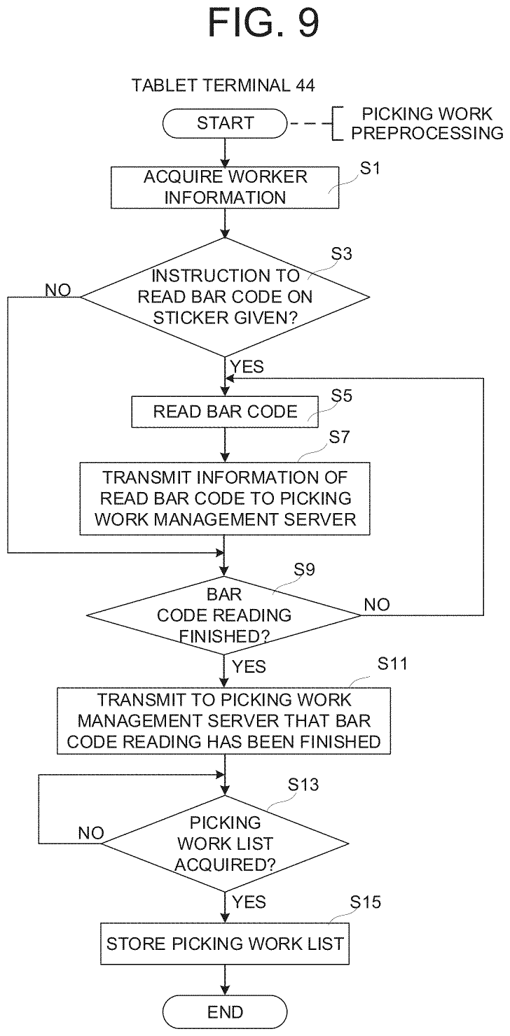

In the program storage area 80, a preprocessing program 80a, a picking work management program 80b, etc., are stored. The preprocessing program 80a is a program for preprocessing (FIG. 9) to perform the picking work in accordance with the picking work management program 80b. The picking work management program 80b is a program for managing the picking work using the bar code reader 46 and/or 50. One of the features of the picking work management program 80b is to display, with the tablet terminal 44, GUI images (guide images) one by one to a worker who is to execute the picking work by using the AGV 24, thereby preventing a work error as much as possible.

The data storage area 82 stores map data 82a showing the whole of the warehouse 100 shown in FIG. 2, and also stores route data 82b showing each movement (traveling) route for the AGV in question, which is to be generated by the picking work management server 20 and transmitted from the picking work management server 20.

The data storage area 82 further stores display image data 82c for displaying the above GUI image, and bar code information data 82d, which is obtained by reading the bar code on the delivery request label 26 shown in FIG. 4 in preparatory work for the picking work, more specifically, data such as the item number of the commodity, quantity, shelf number, the name of the customer, and the customer ID.

Next, referring to FIG. 9, a flowchart showing an example of the preprocessing of the picking work to be conducted by the CPU 44a (FIG. 7) incorporated in the tablet terminal 44 will be described. The tablet terminal 44 is removably mounted on the AGV 24 to be used by the picking worker as described above.

As shown in FIG. 9, when the CPU 44a of the tablet terminal 44 starts the picking work preprocessing, the CPU 44a acquires worker information in step S1. Here, the worker information (worker ID) to be input by the picking worker (hereinafter may be simply referred to as a “worker”) by scanning a bar code on an ID card with the bar code reader 46, for example, is acquired.

In the present embodiment, in all cases, the bar code data that is read by the bar code reader 46 or 50 is input to the CPU 62 of the AGV 24 from the scanner interface 74. Further, from the communication device 68, the bar code data is input to the CPU 44a through the communication device 44c of the tablet terminal 44, and is also transmitted to the picking work management server 20.

In the following step S3, it is determined whether a reading instruction to read a bar code on the sticker 26 has been given. If “NO” in step S3, in other words, if no reading instruction has been given, the processing proceeds to step S9. On the other hand, if “YES” in step S3, in other words, if an instruction to read the bar code on the sticker has been given, the bar code 28 (FIG. 4) on the sticker 26 is read in step S5. That is, the CPU 44a of the tablet terminal 44 instructs reading of the bar code by displaying a message such as “Please read the bar code” on a screen of the tablet terminal 44, and acquires information (data) of the bar code read by the bar code reader 46 (FIG. 5), for example, as described above.

In step S7, the data of the read bar code is transmitted to the picking work management server 20. That is, the processing of the above step S7 serves as a picking work target registrator that registers a commodity, which is a picking work target.

Then, in step S9, it is determined whether the reading of the bar code has been finished. Here, the tablet terminal 44 determines whether an end of the bar code reading has been instructed by the worker.

If “NO” in step S9, in other words, if the reading of the bar code is not to be finished, the processing returns to step S3, and a reading process of the bar code on the next sticker is executed. On the other hand, if “YES” in step S9, in other words, if the reading of the bar code has been finished, the picking work management server 20 is notified, in step S11, that the reading of the bar code has been finished. Further, in step S13, it is determined whether a picking work list to be executed has been acquired from the picking work management server 20 by using the tablet terminal 44. The picking work list corresponds to a summary of information, such as the item number of the commodity, quantity, shelf number, the name of the customer, and the customer ID, included in the bar code data which the picking work management server 20 received from the tablet terminal 44, for each sticker 26.

If “NO” in step S13, the processing returns to step S13 to wait for reception of the picking work list from the picking work management server 20. Then, if step S13 is eventually determined to be “YES”, in other words, if the picking work list is received, the acquired picking work list is stored in the memory 44b (FIG. 8) in step S15, and pre-work processing is ended.

Note that in the present embodiment, data of the read bar code is transmitted to the picking work management server 20 each time the reading of the bar code is executed. However, data of all of the read bar codes may be transmitted after reading of all of the bar codes has been finished.

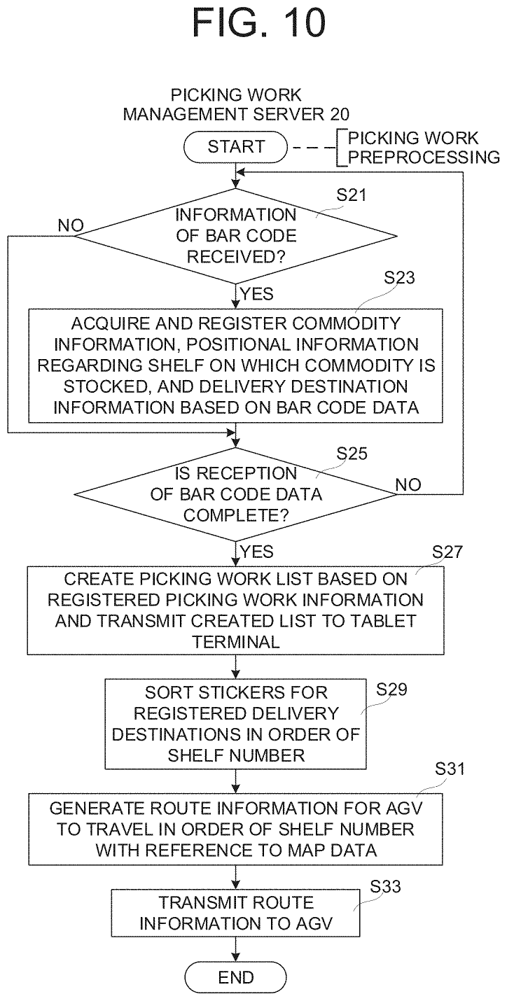

A program for picking work preprocessing, which is to be conducted by the picking work management server 20 as shown in FIG. 10, is set in a memory (not shown) of the picking work management server 20. In the first step S21 of the preprocessing, it is determined whether the information of the bar code 28 (bar code information) of the sticker 26 (FIG. 4) is received. The bar code information is sent from the tablet terminal 44, as shown in FIG. 9. If “NO” in step S21, in other words, if the bar code data of the sticker 26 is not received, the processing proceeds to step S25 to determine whether reception of all pieces of bar code data is complete.

When it is determined as “YES” in step S21, in step S23, picking work information such as the item number of the commodity, quantity, shelf number, the name of the customer, and the customer ID is acquired, on the basis of the bar code data. In step S25, the procedure of step S23 is repeated until it is determined that reception of all pieces of bar code information is complete.

Then, when it is determined, in step S25, that reception of all pieces of picking work information is complete, the picking work management server 20 creates the picking work list in step S27, on the basis of the bar code data including, for example, the item number of the commodity, quantity, shelf number, the name of the customer, and the customer ID, and stores (registers) the picking work list in the memory (not shown) of the picking work management server 20. Then, the picking work list is transmitted to the tablet terminal 44.

In the next step S29, the CPU 44a sorts the delivery destinations (customers) respectively indicated by the bar code data obtained in step S23 in the order of shelf number.

In the next step S31, referring to the map data, the picking work management server 20 generates information on a route that is most efficient for the AGV 24 to travel, in accordance with the order of the sorted shelf numbers. Next, in step S33, the picking work management server 20 transmits the above route information to the AGV 24, and ends the picking work preprocessing. That is, steps S29 and S31 of the above preprocessing serve as route information generator.

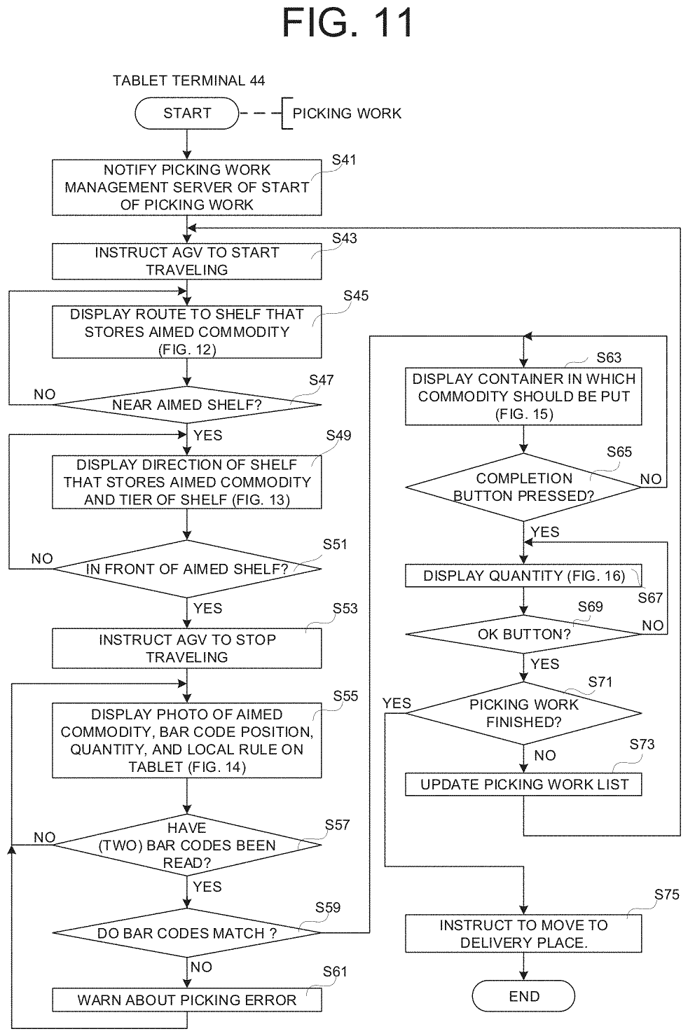

FIG. 11 is a flowchart showing an example of picking work processing of the CPU 44a of the tablet terminal 44 shown in FIG. 1. The picking work processing is executed in accordance with the picking work management program 80b shown in FIG. 8, and the picking work processing is started in response to a start button (not shown) being operated by the picking worker. Note that all of the stickers 26 (FIG. 4) for a plurality of commodities that provide instructions for the picking work to be executed in the future are issued to the picking worker.

When the picking work processing is started, in step S41, the picking work management server 20 is notified of the start of the picking work.

In the subsequent step S43, the CPU 44a instructs the AGV 24 to start traveling. In accordance with the above traveling start instruction, the CPU 62 of the AGV 24 starts the traveling in accordance with the route data previously sent from the picking work management server 20 in step S33 shown in FIG. 10. Since autonomous travel by the AGV 24 is well known and is not the main feature of the embodiment, providing detailed description of the above is omitted. The AGV 24 can also identify the current position by reading the RF tag laid in the warehouse 100 by means of the tag reader 60 (FIG. 7) while traveling, and transmits the current position data to the tablet terminal 44 as needed.

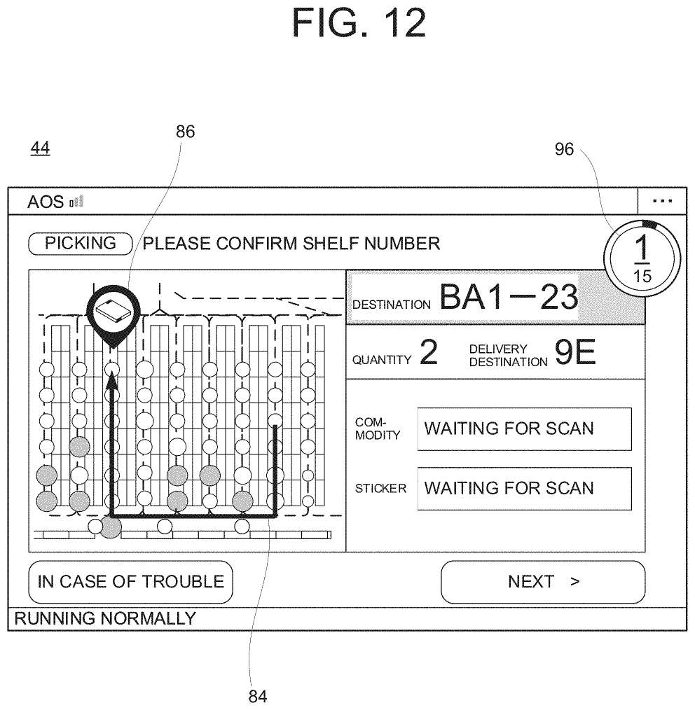

In the next step S45, the CPU 44a of the tablet terminal 44 uses the display image data 82c, which has been generated on the basis of the map data 82a and the route data 82b, to display a route to the shelf that stores the aimed commodity, as shown in FIG. 12. In FIG. 12, a slightly thick solid line 84 corresponds to route display, and a circle 86 is displayed at the end of the route display 84. In the circle 86, a photograph of the external appearance of the aimed commodity is displayed.

However, in a case where the picking worker uses the AGV 24 that autonomously travels to collect cargo, the route display in step S45 may be omitted. However, when the picking work is to be performed by using a platform truck (not shown) that does not autonomously travel, the route display as shown in FIG. 12 by the tablet terminal 44 is very useful. That is, in this case, the picking worker may perform the picking work while carrying the tablet terminal 44.

In the next step S47, the CPU 44a determines whether the AGV 24 has come close to the aimed shelf, on the basis of the current position data to be sent from the AGV 24 moment by moment. In FIG. 2, when the AGV 24 has come close to a pickup location 106 that is immediately before the pickup (picking) location closest to the aimed shelf, for example, it can be determined as “YES” in step S47.

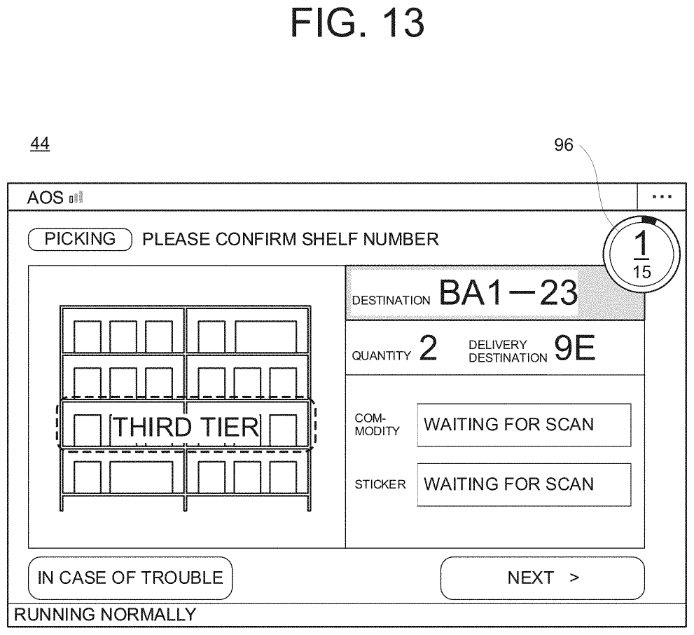

When it is determined as “YES” in step S47, the CPU 44a uses, in step S49, the display image data 82c to display, as shown in FIG. 13, the shelf number of the shelf that stores the aimed commodity, i.e., “BA1-23” in this case, and the tier of that shelf, i.e., “third tier” in this case, on the tablet terminal 44, as an example of detailed information about the storage area. In this way, by displaying the shelf number and the position (tier) of the shelf, the picking worker can quickly find the aimed commodity. The guide image in FIG. 13 can be deemed as a storage area guide image.

After that, in step S51, the CPU 44a determines whether the AGV 24 has arrived at the picking location 106 in front of the aimed shelf BA1-23, on the basis of the current position data sent from the AGV 24.

When it is determined as “YES” in step S51, the CPU 44a instructs, in step S53, the AGV 24 to stop traveling. That is, the AGV 24 is stopped at the picking location 106 in front of the aimed shelf.

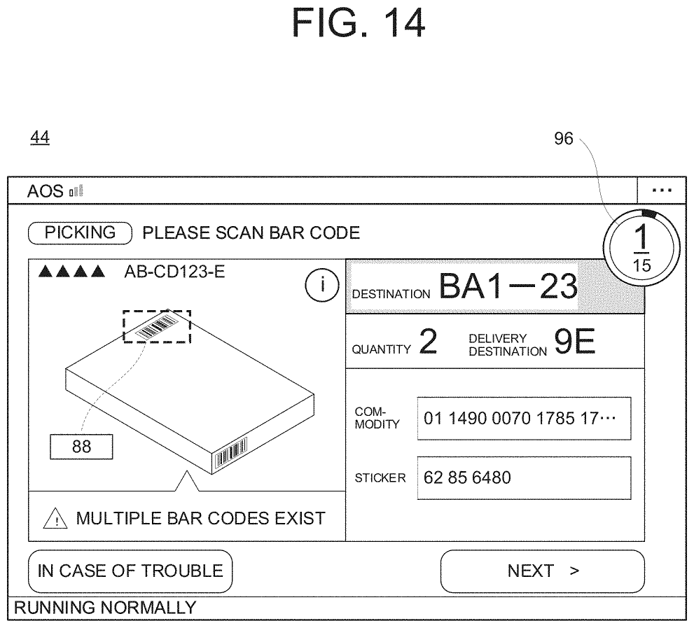

In this way, when the AGV 24 stops at the picking location 106 in front of the aimed shelf, the tablet terminal 44 displays, in step S55, a commodity guide image as shown in FIG. 14, for example. As an example, the commodity guide image displays, as commodity detailed information, a photograph 86 of the aimed commodity, a position of the bar code to be read from the commodity, and the number of commodities to be picked. In displaying the above, a local rule other than the above may be displayed. The local rule is a rule unique to the warehouse 100, a customer, or a picking worker, etc.

By looking at the GUI image as shown in FIG. 14 being displayed in step S55, the picking worker picks a commodity having the same external appearance as that of the commodity photograph 86 displayed as the commodity detailed information. As shown in FIG. 14, in a case where the commodity photograph 86 includes two or more bar codes, which bar code should be read is specified by a reading instruction 88 indicating the position of the bar code to be read. The reading instruction 88 is an example of the local rule.

In accordance with the reading instruction 88 of the tablet terminal 44, the picking worker reads the specified bar code by the bar code reader 46 or 50 (FIG. 5), and also reads the bar code (the bar code 28 shown in FIG. 4) of the sticker 26 carried with the picking worker. Pieces of data of the above bar codes are stored in the data storage area 82 (FIG. 8).

Then, in the next step S59, it is determined whether the two pieces of bar code data read by the picking worker agree with each other. That is, it is determined whether the bar code recorded on the sticker matches with the bar code of the picked commodity. By the above determination, a kind of inspection function of determining whether the picking worker has picked a correct commodity indicated by the sticker is performed.

If the two pieces of bar code data do not agree with each other, a warning is given by the tablet terminal 44, in step S61, that the picked commodity is incorrect. For example, a warning message such as “Please check the commodity” may be displayed. Then, the picking worker who has seen the warning display of step S61 can pick the correct commodity.

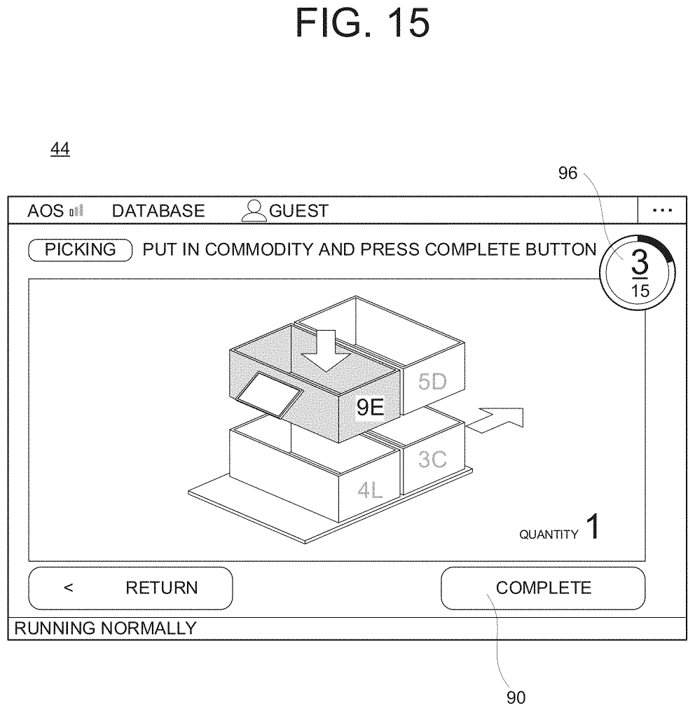

When it is determined that the two pieces of bar code data agree with each other, in step S59, the CPU 44a displays, in the next step S63, a GUI image shown in FIG. 15, which serves as a container indicator that indicates the container in which the commodity should be put. This GUI image (container guide image) shows that the container for putting in the commodity that has been correctly picked previously is the container for customer 9E. Thus, the worker puts the commodity correctly picked previously in the container displayed as 9E as specified. In this case, the number of commodities to be picked is two. Therefore, after putting in two commodities, the worker operates (touches) a complete button 90 included in the GUI image of FIG. 15, and enters completion of the picking of the commodities in question.

Here, the picking worker puts the picked commodity in the indicated container after affixing the sticker 26 on the picked commodity. If the picked commodity corresponds to a lot with a quantity of one, one sticker may be affixed to that one commodity. However, in a case where an order unit of the commodity is plural (i.e., the case of a bulk purchase) as in the embodiment (a lot with a quantity of two in the embodiment), one sticker is affixed for each unit of the bulk purchase.

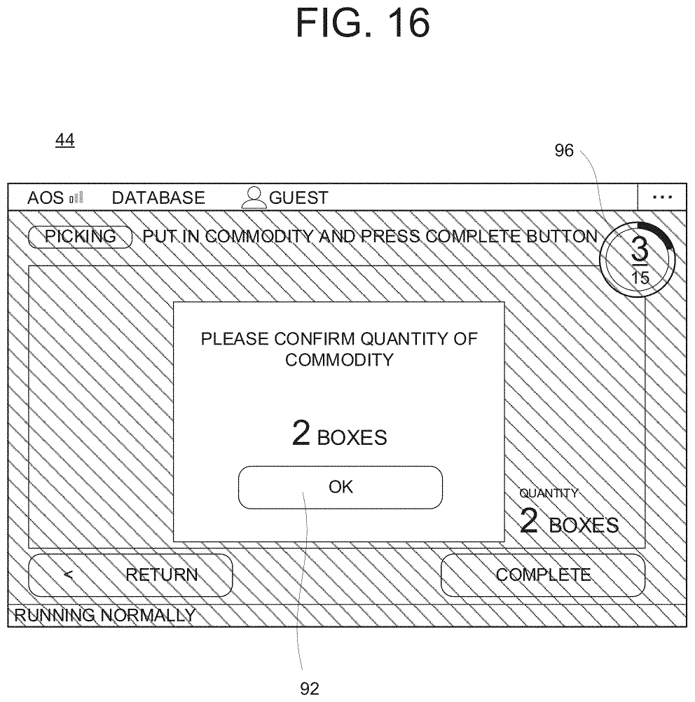

Next, a GUI image as shown in FIG. 16 is displayed. In FIG. 16, the number of commodities to be picked is displayed as “2”, and the worker is informed that two commodities should have been picked. For example, if the picking worker had picked only one target commodity, he/she would know from the GUI image of FIG. 16 that the number of commodities which should have been picked was two, and can pick one more commodity. Then, after the picking worker correctly puts two correct commodities in the specified container, he/she operates an OK button 92 of the GUI image of FIG. 16. Therefore, it is determined as “YES” in step S69.

Then, in step S71, the CPU 44a determines whether the picking work has been finished. If there is nothing left in the picking work list, it is determined as “YES” in step S71. If there is something left in the picking work list, it is determined as “NO” in step S71. In the next step S73, the picking work list is updated, and the processing proceeds to the next picking work.

When it is determined as “YES” in step S71, in other words, when the picking work has been finished, the CPU 44a instructs the AGV 24 to move to a delivery place, in step S75.

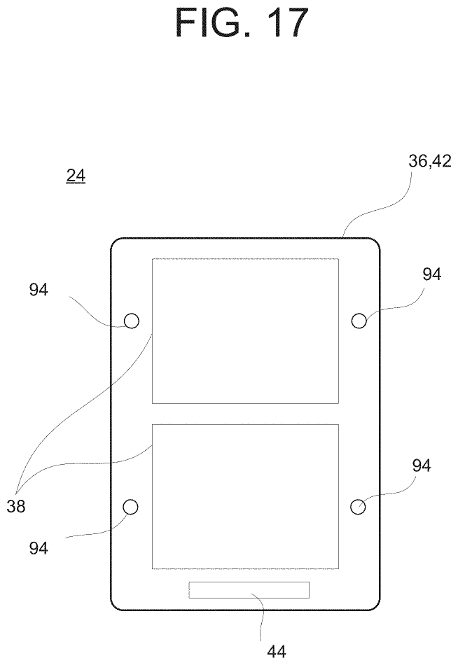

In the embodiment described above, the GUI image of FIG. 15 is displayed, so that one of a plurality of (four in the present embodiment) containers that can be visually recognized in the aforementioned image is displayed in a display mode different from that of the other containers. By doing so, the picking worker is instructed or informed of the container in which the picked commodity should be put. Meanwhile, in an embodiment shown in FIG. 17, LEDs 94, 94, . . . are provided on both sides (or one side) of the container placement boards 36 and 42 of the AGV 24 to correspond to the places where the containers 38 are to be placed on the container placement boards 36 and 42, as container informing portion. In a case where the container in which the picked commodity should be put is to be indicated (i.e., when the container indicator is to function), the corresponding LED is lit. If the container displayed as 9E in FIG. 15 is to be indicated, the LED 94 on the side where the tablet terminal 44 is installed may be lit on the upper placement board 42.

Note that the embodiment of FIG. 17 may also be used in combination with the embodiment in which the GUI image of FIG. 15 is displayed.

Although detailed explanation is omitted, a circular object 96 displayed in the upper right of the GUI images shown in FIGS. 12 to 16 is a progress display showing the degree of a delay or promptness in the picking work (for each sticker). In the progress display 96 of the present embodiment, a denominator (“15” in the present embodiment) indicates the types of commodities which the picking worker needs to collect, and a numerator (“1” or “3” in the present example) indicates the number of commodities that have been collected so far. The display is performed with different colors depending on the state of progress, such as the state where the picking work is in progress smoothly or the state where the work is slightly delayed.

Further, in the above-described embodiment, whether the two pieces of bar code data agree with each other is determined in step S59 of FIG. 11. However, the determination may be performed not only in terms of whether the two agree with each other completely, but also in terms of whether they have a predetermined correspondence relationship. In other words, step S59 is a process for determining whether the commodity indicated by the sticker 26 has been correctly picked. Thus, as long as this determination can be made, whether or not the two have a predetermined correspondence relationship may be determined.

What is claimed is:

1. A picking work assistance device which assists multi-picking work of sequentially picking commodities that are each stored in a storage area, using a carrier vehicle on which a plurality of containers corresponding individually to a plurality of customers, respectively, are placed, the picking work assistance device comprising:
a picking work target registrator that registers a commodity, which is a picking work target; and
a container indicator that indicates which of the plurality containers the picked commodity is to be put in.

2. The picking work assistance device according to claim 1, wherein:
the carrier vehicle comprises a guide image display portion which guides the picking work; and
the container indicator displays, by the guide image display portion, a container guide image as a guide to the container in which the commodity should be put from among the plurality of containers.

3. The picking work assistance device according to claim 2, wherein the guide image display portion displays, when the carrier vehicle arrives at the storage area of the commodity registered by the picking work target registrator, a commodity guide image showing information on the commodity to be picked.

4. The picking work assistance device according to claim 2, wherein the guide image display portion displays, when the carrier vehicle is close to the storage area of the commodity, a storage area guide image showing information on the storage area.

5. The picking work assistance device according to claim 1, further comprising a route information generator which generates information on a traveling route for the carrier vehicle to perform the picking work of the commodity registered by the picking work target registrator, based on map data and the information on the storage area of the registered commodity.

6. The picking work assistance device according to claim 5, wherein the route information generator generates the route information, based on information on the storage areas corresponding to the commodities, which are the picking work targets, of the plurality of customers for whom multi-picking is intended.

7. The picking work assistance device according to claim 6, wherein:
the route information generator sorts the commodities, which are the picking work targets, of the plurality of customers by the storage areas; and
the route information generator generates the route information such that the commodities, which are the picking work targets, sorted by the storage areas are sequentially picked.

8. The picking work assistance device according to claim 1, wherein:
the carrier vehicle comprises an informing portion at places corresponding to positions where the plurality of containers are placed, the informing portion informing which of the plurality containers the picked commodity is to be put in; and
the container indicator indicates, by means of the informing portion, the container in which the commodity should be put from among the plurality of containers.

9. A non-transitory computer-readable recording medium having stored thereon a picking work assistance program which is executed by a computer of a picking work assistance device, which assists multi-picking work of sequentially picking commodities that are each stored in a storage area, using a carrier vehicle on which a plurality of containers corresponding individually to a plurality of customers, respectively, are placed, the picking work assistance program causing the computer to function as:
a picking work target registrator that registers a commodity, which is a picking work target; and
a container indicator that indicates which of the plurality containers the picked commodity is to be put in.
